(19) United States
(12) Patent Application Publication
(10) Pub. No.: US 2026/0269242 A1
(43) Pub. Date: Sep. 10, 2026

(54) BATTERY AND BATTERY PACK

(71) Applicant: KABUSHIKI KAISHA TOSHIBA, Kawasaki-shi (JP)

(72) Inventors: Hiroki ITO, Yokohama Kanagawa (JP); Naoki NISHIO, Yokohama Kanagawa (JP)

(73) Assignee: KABUSHIKI KAISHA TOSHIBA, Kawasaki-shi (JP)

(21) Appl. No.: 19/663,656

(22) Filed: Apr. 30, 2026

Related U.S. Application Data
(63) Continuation of application No. PCT/JP2024/033554, filed on Sep. 19, 2024.

(51) Int. Cl. H01M 4/525; H01M 4/02; H01M 10/0525; H01M 10/0569; H01M 50/249

(52) U.S. Cl. CPC H01M 4/525; H01M 10/0525; H01M 10/0569; H01M 50/249; H01M 2004/021; H01M 2004/028; H01M 2220/20; H01M 2300/0037

(57) ABSTRACT

According to an embodiment, a battery includes a positive electrode, a negative electrode, and an electrolyte. The positive electrode contains a first oxide. In a hard X-ray photoelectron spectroscopic spectrum for a surface of the positive electrode, a ratio B/A is 0.07 or more and 0.20 or less. The negative electrode contains a lithium titanium-containing oxide. In a hard X-ray photoelectron spectroscopic spectrum for a surface of the negative electrode, a ratio D/C is 0.75 or more and 1.8 or less. The electrolyte contains a carboxylic acid ester and a cyclic carbonate. A volume of the carboxylic acid ester is at least 2.3 times a volume of the cyclic carbonate.

### CROSS-REFERENCE TO RELATED APPLICATION

This application is a Continuation Application of PCT Application No. PCT/JP2024/033554, filed Sep. 19, 2024, the entire contents of which are incorporated herein by reference.

### FIELD

Embodiments described herein relate generally to a battery and a battery pack.

### BACKGROUND

In recent years, a nonaqueous electrolyte battery is expected to be applied to a large system for electric aircraft, power storage or the like in addition to an attempt to replace gasoline with the nonaqueous electrolyte battery as a power source for an electric vehicle (EV), a hybrid electric vehicle (HEV) or the like. Therefore, there is a demand for improvement in capacity characteristics, large current output performance, and safety.

Examples of a positive electrode active material of the nonaqueous electrolyte battery include nickel-cobalt-lithium manganate. When a ratio of nickel (Ni) contained in the nickel-cobalt-lithium manganate is increased, a positive electrode active material having a high capacity can be obtained.

As a method for improving the safety of a nonaqueous electrolyte battery, a method using a flame-retardant solvent such as a fluorine-containing solvent or a solvent having a high flash point as a solvent of an electrolytic solution has been proposed.

### BRIEF DESCRIPTION OF DRAWINGS

FIG. 1 is a cross-sectional view of an example of a battery according to an embodiment cut in a thickness direction.

FIG. 2 is an enlarged cross-sectional view of a part A of FIG. 1.

FIG. 3 is a partially cutaway perspective view of another example of the battery according to the embodiment.

FIG. 4 is a perspective view illustrating another example of an electrode group included in another example of the battery according to the embodiment.

FIG. 5 is an exploded perspective view of an example of a battery pack according to an embodiment.

FIG. 6 is a block diagram illustrating an electric circuit of the battery pack illustrated in FIG. 5.

FIG. 7 illustrates an example of a hard X-ray photoelectron spectroscopic spectrum for a positive electrode included in the battery according to the embodiment.

FIG. 8 illustrates another example of the hard X-ray photoelectron spectroscopic spectrum for the positive electrode included in the battery according to the embodiment.

FIG. 9 illustrates an example of a hard X-ray photoelectron spectroscopic spectrum for a negative electrode included in the battery according to the embodiment.

FIG. 10 illustrates another example of the hard X-ray photoelectron spectroscopic spectrum for the negative electrode included in the battery according to the embodiment.

### DETAILED DESCRIPTION

According to an embodiment, a battery is provided. The battery includes a positive electrode, a negative electrode, and an electrolyte. The positive electrode contains an oxide containing a transition metal. The transition metal includes nickel, cobalt, and manganese. In the oxide, a number A_{Ni} of atoms of the nickel is 0.7 or more when a total number of atoms of the transition metals is 1. In a hard X-ray photoelectron spectroscopic spectrum for a surface of the positive electrode, a ratio B/A of an area B of a peak having a peak top in a range of 683 eV or more and 686 eV or less to an area A of a peak having a peak top in a range of 851 eV or more and 868 eV or less is 0.07 or more and 0.20 or less. The negative electrode contains a lithium titanium-containing oxide. In a hard X-ray photoelectron spectroscopic spectrum for a surface of the negative electrode, a ratio D/C of an area D of a peak having a peak top in a range of 685 eV or more and 687.5 eV or less to an area C of a peak having a peak top in a range of 455 eV or more and 469 eV or less is 0.75 or more and 1.8 or less. The electrolyte contains a carboxylic acid ester and a cyclic carbonate. A volume of the carboxylic acid ester is at least 2.3 times a volume of the cyclic carbonate.

According to another embodiment, a battery pack is provided. The battery pack includes the battery according to the embodiment.

Embodiments will be described later with reference to the drawings. Throughout the embodiments, the same components will be denoted by the same reference numerals and redundant description thereof will not be provided. Further, each drawing is a schematic diagram for explaining the embodiments and for promoting the understanding thereof. Though there are parts different from those of an actual device in shape, dimensions, ratio, and the like, these structural designs may properly be changed taking the following description and known technologies into consideration.

### First Embodiment

According to a first embodiment, a battery is provided. The battery includes a positive electrode, a negative electrode, and an electrolyte. The positive electrode contains an oxide containing a transition metal. The transition metal includes nickel, cobalt, and manganese. In the oxide, A_{Ni} (a number of atoms of the nickel) is 0.7 or more when a total number of atoms of the transition metals is 1. In a hard X-ray photoelectron spectroscopic spectrum for a surface of the positive electrode, a ratio B/A of an area B of a peak having a peak top in a range of 683 eV or more and 686 eV or less to an area A of a peak having a peak top in a range of 851 eV or more and 868 eV or less is 0.07 or more and 0.20 or less. The negative electrode contains a lithium titanium-containing oxide. In a hard X-ray photoelectron spectroscopic spectrum for a surface of the negative electrode, a ratio D/C of an area D of a peak having a peak top in a range of 685 eV or more and 687.5 eV or less to an area C of a peak having a peak top in a range of 455 eV or more and 469 eV or less is 0.75 or more and 1.8 or less. The electrolyte contains a carboxylic acid ester and a cyclic carbonate. A volume of the carboxylic acid ester is at least 2.3 times a volume of the cyclic carbonate.

In the present specification, the “oxide containing nickel, cobalt, and manganese, wherein, in the oxide, A_{Ni} (a number of atoms of the nickel) is 0.7 or more when a total number of atoms of the transition metals is 1” is sometimes referred to as first oxide.

The oxide containing nickel, cobalt, and manganese, wherein, in the oxide, the number A_{Ni} of atoms of the nickel is 0.7 or more when the total number of atoms of the transition metals is 1 (first oxide) has a high capacity. However, the first oxide has a high capacity but low thermal stability. Therefore, the positive electrode containing the first oxide easily generates heat.

Conventionally, as a solvent of an electrolytic solution, a solvent obtained by mixing a chain carbonate and a cyclic carbonate is used. The cyclic carbonate has a high relative permittivity, promotes dissociation of lithium ions, and contributes to lithium ion conduction, but has a low decomposition start temperature and is easily decomposed.

Therefore, when the positive electrode containing the first oxide is combined with the conventional electrolytic solution, decomposition of the electrolytic solution easily proceeds. In particular, decomposition of the cyclic carbonate easily proceeds. Therefore, there is a problem of gas generation. In addition, since heat can be generated in a decomposition reaction of the electrolytic solution, the decomposition reaction of the electrolytic solution further easily proceeds by the heat. This problem is likely to occur, for example, when the battery is overcharged. When the battery is overcharged, the positive electrode containing the first oxide may have excessively high energy. When such a positive electrode and the electrolytic solution come into contact with each other, the decomposition reaction of the electrolytic solution particularly easily proceeds.

On the other hand, the electrolyte included in the battery according to the embodiment contains a carboxylic acid ester and a cyclic carbonate. A volume of the carboxylic acid ester is at least 2.3 times a volume of the cyclic carbonate.

The carboxylic acid ester has a high permittivity and a low viscosity. Therefore, even when a proportion of the carboxylic acid ester in the electrolyte is increased, an ionic conductivity of the electrolyte can be maintained high. Therefore, since the electrolyte containing a carboxylic acid ester and a cyclic carbonate has a high ionic conductivity, input/output performance can be enhanced.

Further, the carboxylic acid ester has a higher decomposition start temperature than the cyclic carbonate. In the electrolyte, the stability of the electrolyte tends to be able to be improved as the content of the carboxylic acid ester increases relative to the cyclic carbonate. In the embodiment, the volume of the carboxylic acid ester contained in the electrolyte is at least 2.3 times the volume of the cyclic carbonate. Therefore, since the stability of the electrolyte can be improved, the generation of gas and heat can be made difficult to proceed even when the electrolyte is combined with the positive electrode containing the first oxide. Therefore, safety can be improved. However, from the viewpoint of keeping the ionic conductivity of the electrolyte high, the electrolyte needs to contain a cyclic carbonate.

The carboxylic acid ester has low stability at a low potential, and thus is easily reductively decomposed in the negative electrode. In the battery according to the embodiment, since the negative electrode contains a lithium titanium-containing oxide having a relatively high potential, it is possible to suppress an excessive decrease in negative electrode potential. Therefore, gas generation due to reductive decomposition of the carboxylic acid ester in the negative electrode can be suppressed, so that input/output performance can be improved.

The ratio B/A of the area B of the peak having a peak top in the range of 683 eV or more and 686 eV or less to the area A of the peak having a peak top in the range of 851 eV or more and 868 eV or less, in the hard X-ray photoelectron spectroscopic (HAXPES) spectrum for the surface of the positive electrode, can be an index of a degree of exposure of the first oxide on the surface of the positive electrode.

For example, small B/A may mean a large proportion of the first oxide on the surface of the positive electrode. That is, it may mean a high degree of exposure of the first oxide on the surface of the positive electrode.

Conversely, large B/A may mean a small proportion of the first oxide on the surface of the positive electrode. For example, since a coating is formed on at least a part of a surface of the positive electrode, it may mean a low degree of exposure of the first oxide. Therefore, it is possible to suppress contact and reaction between the carboxylic acid ester contained in the electrolyte and the first oxide. Therefore, oxidative decomposition of the carboxylic acid ester can be suppressed. Therefore, heat generation of the battery due to decomposition of the electrolyte can be reduced, and gas generation can be suppressed. Therefore, for example, progress of gas generation can be suppressed even in a high-temperature environment.

In the battery according to the embodiment, the B/A is 0.07 or more. Therefore, the exposure of the first oxide on the surface of the positive electrode is suppressed. Therefore, oxidative decomposition of the carboxylic acid ester can be suppressed. In addition, since a heat generation amount of the battery can be reduced, safety can be improved. Since the B/A is 0.20 or less, an amount of the coating formed on the surface of the positive electrode is not excessively large. Therefore, since movement of electric charge in the battery can be smoothly maintained, resistance can be maintained low.

The ratio D/C of the area D of the peak having a peak top in the range of 685 eV or more and 687.5 eV or less to the area C of the peak having a peak top in the range of 455 eV or more and 469 eV or less, in the hard X-ray photoelectron spectroscopic spectrum for the surface of the negative electrode, can be an index of a degree of exposure of the lithium titanium-containing oxide on the surface of the negative electrode.

For example, small D/C may mean a large proportion of the lithium titanium-containing oxide on the surface of the negative electrode. That is, it may mean a high degree of exposure of the lithium titanium-containing oxide on the surface of the negative electrode.

Conversely, large D/C may mean a small proportion of the lithium titanium-containing oxide on the surface of the negative electrode. For example, since a coating is formed on at least a part of a surface of the negative electrode, it may mean a low degree of exposure of the lithium titanium-containing oxide. Therefore, it is possible to suppress contact and reaction between the carboxylic acid ester contained in the electrolyte and the lithium titanium-containing oxide. Therefore, since the reductive decomposition of the carboxylic acid ester can be suppressed, gas generation can be suppressed.

In the battery according to the embodiment, the D/C is 0.75 or more. Therefore, the exposure of the lithium titanium-containing oxide on the surface of the negative electrode is suppressed. Therefore, reductive decomposition of the carboxylic acid ester can be suppressed. Since the D/C is 1.8 or less, an amount of the coating formed on the surface of the negative electrode is not excessively large. Therefore, since movement of electric charge in the battery can be made smooth, resistance can be maintained low. Therefore, the battery according to the embodiment can be improved in safety and input/output performance.

The battery according to the embodiment will be described in more detail.

The battery according to the embodiment may be, for example, a lithium battery or a lithium ion battery using a lithium ion as a carrier. The battery according to the embodiment may be a secondary battery. The secondary battery may be a nonaqueous electrolyte secondary battery in which the electrolyte is a nonaqueous electrolyte.

The first oxide is preferably an oxide represented by the general formula LiₓN_{1-y-z}Co_{y}Mn_{z}O₂, wherein x satisfies 0<x≤1, y satisfies 0<y<0.3, and z satisfies 0<z<0.3.

When the first oxide is an oxide represented by the general formula LiₓN_{1-y-z}Co_{y}Mn_{z}O₂, the transition metal contained in the first oxide consists of nickel, cobalt, and manganese.

As described above, in the first oxide, the number A_{Ni} of atoms of the nickel is 0.7 or more when the total number of atoms of the transition metals is 1. In the general formula LiₓN_{1-y-z}Co_{y}Mn_{z}O₂, a sum of subscripts of the nickel, the cobalt, and the manganese, which are transition metals, is 1. That is, when the first oxide is an oxide represented by the general formula LiₓN_{1-y-z}Co_{y}Mn_{z}O₂, the number of atoms A_{Ni} of the nickel when the total number of atoms of the transition metals is 1 corresponds to 1−y−z which is the subscript of the nickel in the general formula. In the general formula LiₓN_{1-y-z}Co_{y}Mn_{z}O₂, the 1−y−z is 0.7 or more.

The positive electrode according to the embodiment may contain positive electrode active material particles containing the first oxide. In a particle size distribution chart of the positive electrode active material particles obtained by a laser diffraction scattering method, a ratio d90/d10 of d90 to d10 is preferably 4 or less. The particle size distribution is a volume-based cumulative frequency distribution that is accumulated from a small particle size side of the particles. d10 is a particle size at which a cumulative frequency from a small particle size side of the cumulative frequency distribution is 10%. d90 is a particle size at which the cumulative frequency from the small particle size side of the cumulative frequency distribution is 90%. A small value of d90/d10 may mean a small variation in particle size. A small variation in the particle size of the positive electrode active material particles is less likely to result in formation of a grain boundary that may cause an increase in resistance. Therefore, the resistance of the positive electrode can be reduced.

When the first oxide contained in the positive electrode active material particles is a single crystal, the d90/d10 of the positive electrode active material particles may be 4 or less.

In general, when the active material particle cracks, the performance of the battery containing the active material particle may change due to an increase in the surface area of the active material particles. For example, the active material particles may crack due to expansion and contraction during charging and/or discharging. As a charge-and-discharge cycle is repeated, the particles are more likely to crack.

When the first oxide contained in the positive electrode active material particles is a single crystal, the positive electrode active material particles can hardly crack. As a result, it is possible to suppress an increase in the surface area occupied by the first oxide due to cracking of the particles, thereby making it possible to suppress contact between the first oxide and the electrolyte. Therefore, the decomposition of the electrolyte can be further suppressed.

When the first oxide contained in the positive electrode active material particles is a single crystal, the d90/d10 of the positive electrode active material particles may be 4 or less. In addition, an average particle size of the positive electrode active material particles may be 2 μm or more and 8 μm or less. In addition, a breaking strength of the positive electrode active material particles can be 30 MPa or more and 300 MPa or less. In other words, when the d90/d10, the average particle size, and/or the breaking strength of the positive electrode active material particles are within the above ranges, the first oxide contained in the positive electrode active material particles can be a single crystal, and thus an increase in specific surface area occupied by the first oxide due to cracking of the positive electrode active material particles can be suppressed. Hence, the decomposition of the electrolyte can be suppressed. Therefore, heat generation and gas generation due to the decomposition of the electrolyte can be suppressed. Therefore, the safety and input/output performance of the battery can be improved.

The positive electrode active material particles are likely to crack when the charge-and-discharge cycle is repeated. Therefore, when the battery according to the embodiment is a secondary battery, if the d90/d10, the average particle size and/or the breaking strength of the positive electrode active material particles are/is within the above range(s), the decomposition of the electrolyte can be more effectively suppressed, which is preferable.

Hereinafter, the battery according to the embodiment will be described in more detail.

The carboxylic acid ester contained in the electrolyte preferably contains no fluorine atom. The carboxylic acid ester containing no fluorine atom can reduce gas generation and resistance as compared with a carboxylic acid ester containing a fluorine atom.

Examples of the carboxylic acid ester containing no fluorine atom include a carboxylic acid ester represented by the following rational formula R—COO—R′, wherein each of R and R′ is a hydrocarbon group represented by CₓH_{y}. The subscripts x and y preferably satisfy y=2x+1. That is, each of R and R′ is preferably a saturated hydrocarbon group. The saturated hydrocarbon group contains only x carbon atoms and y hydrogen atoms, and therefore contains no fluorine atom. The saturated hydrocarbon group is preferable because it is considered to have low reactivity as compared with an unsaturated hydrocarbon group containing an unsaturated bond such as a double bond.

Examples of the carboxylic acid ester which contains no fluorine atom and is represented by the rational formula R—COO—R′ wherein each of R and R′ is a saturated hydrocarbon group include propyl propionate, ethyl propionate, methyl propionate, ethyl acetate, methyl acetate, propyl butyrate, ethyl butyrate, and methyl butyrate.

As the number of carbon atoms contained in one molecule of the carboxylic acid ester is smaller, the permittivity tends to be higher and the viscosity tends to be lower. Conductivity tends to be improved as the permittivity of the carboxylic acid ester is higher or the viscosity of the carboxylic acid ester is lower. Therefore, the input/output performance can be improved as the number of carbon atoms per molecule of the carboxylic acid ester is smaller. However, the number of carbon atoms contained in one molecule of the carboxylic acid ester is preferably 6 or more. A carboxylic acid ester having 6 or more carbon atoms per molecule has lower flammability than a carboxylic acid ester having 5 or less carbon atoms. Therefore, the carboxylic acid ester is easy to handle, and can improve the safety of the battery. The number of carbon atoms contained in one molecule of the carboxylic acid ester is preferably 6. Among carboxylic acid esters in which the number of carbon atoms contained in one molecule is 6, propyl propionate is most preferable.

In hard X-ray photoelectron spectroscopy for the surface of the positive electrode, for example, a Ni2p_{3/2} peak attributed to nickel atoms can be detected in the range of 851 eV or more and 868 eV or less. The range in which the Ni2p_{3/2} peak attributed to nickel atoms can be detected can be in the range of 851.0 eV or more and 868.0 eV or less. The Ni2p_{3/2} peak may have a peak top in the range of 851 eV or more and 868 eV or less. The peak having a peak top in the range of 683 eV or more and 686 eV or less can be, for example, an F1s peak attributed to lithium fluoride (LiF). The range in which the F1s peak attributed to lithium fluoride (LiF) has a peak top may be 683.0 eV or more and 686.0 eV or less.

That is, the ratio B/A of the area B of the peak having a peak top in the range of 683 eV or more and 686 eV or less to the area A of the peak having a peak top in the range of 851 eV or more and 868 eV or less can be an index indicating a degree of presence of lithium fluoride with respect to nickel atoms on the surface of the positive electrode. On the surface of the positive electrode, nickel atoms can be contained in the first oxide, for example. Lithium fluoride can be contained in the coating, for example.

A large ratio B/A can mean a high degree of presence of lithium fluoride with respect to nickel atoms exposed on the surface of the positive electrode. That is, it can mean a large amount of the coating formed on the surface of the positive electrode. More specifically, for example, when a large amount of a coating containing lithium fluoride is formed or a proportion of lithium fluoride in the coating is high, the ratio B/A can be high. Alternatively, the ratio B/A can also be increased by reducing the number of nickel atoms exposed on the surface of the positive electrode due to formation of a coating on the surface of the positive electrode.

Conversely, a small ratio B/A may mean a small amount of the coating formed on the surface of the positive electrode. In this case, resistance can be reduced, which contributes to improvement of input/output performance.

In hard X-ray photoelectron spectroscopic spectrum for the surface of the negative electrode, for example, a Ti2p_{1/2} peak and a Ti2p_{3/2} peak attributed to titanium atoms can be detected in the range of 455 eV or more and 469 eV or less. The range in which the Ti2p_{1/2} peak and the Ti2p_{3/2} peak attributed to titanium atoms can be detected can be in the range of 455.0 eV or more and 469.0 eV or less. The Ti2p_{1/2} peak and the Ti2p_{3/2} peak may have a peak top in a range of 455 eV or more and 469 eV or less. The peak having a peak top in the range of 685 eV or more and 687.5 eV or less can be, for example, an F1s peak attributed to lithium fluoride (LiF). A lower limit of the range in which the F1s peak attributed to lithium fluoride (LiF) has a peak top may be 685.0 eV.

That is, the ratio D/C of the area D of the peak having a peak top in the range of 685 eV or more and 687.5 eV or less to the area C of the peak having a peak top in the range of 455 eV or more and 469 eV or less can be an index indicating a degree of presence of lithium fluoride with respect to titanium atoms on the surface of the negative electrode. On the surface of the negative electrode, titanium atoms can be contained in the lithium titanium-containing oxide, for example. Lithium fluoride can be contained in the coating, for example.

A large ratio D/C can mean a high degree of presence of lithium fluoride with respect to titanium atoms exposed on the surface of the negative electrode. That is, it can mean a large amount of the coating formed on the surface of the negative electrode. More specifically, for example, when many films containing lithium fluoride are formed or a proportion of lithium fluoride in the coating is high, the ratio D/C can be high. Alternatively, the ratio D/C can also be increased by reducing the number of titanium atoms exposed on the surface of the negative electrode due to formation of a coating on the surface of the negative electrode.

Conversely, a small ratio D/C may mean a small amount of the coating formed on the surface of the negative electrode. In this case, resistance can be reduced, which contributes to improvement of input/output performance. An upper limit of the ratio D/C can be, for example, 1.80.

Next, the battery according to the embodiment will be more specifically described with reference to the drawings.

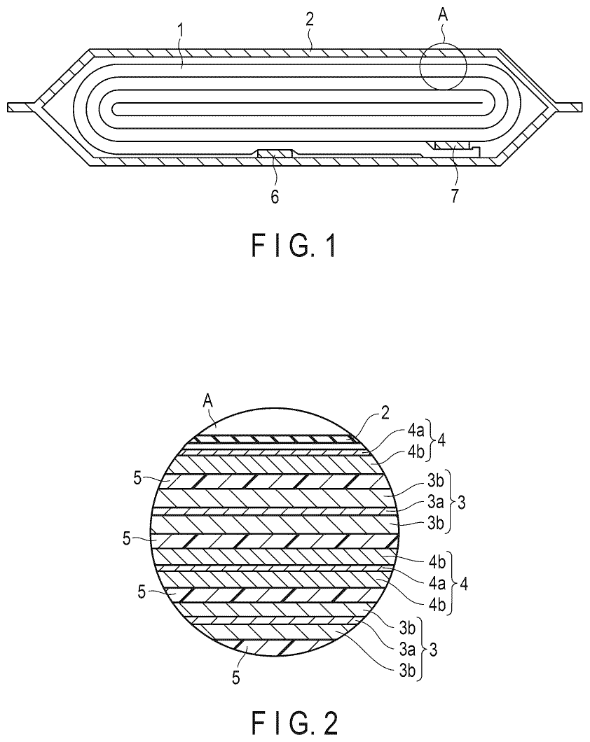

An example of the battery will be described with reference to FIGS. 1 and 2. The flat-type battery illustrated in FIG. 1 includes a flat electrode group 1, a container member 2, a positive electrode terminal 7, a negative electrode terminal 6, and an electrolyte (not illustrated). The container member 2 is a bag-shaped container member made of a laminate film. The electrode group 1 is housed in the container member 2.

The electrode group 1 included in the battery illustrated in FIGS. 1 and 2 is a wound electrode group. As illustrated in FIG. 2, the wound electrode group includes a positive electrode 3, a negative electrode 4, and a separator 5, and is formed by spirally winding and press-molding a stack in which the negative electrode 4, the separator 5, the positive electrode 3, and the separator 5 are stacked in this order from the outside. The electrolyte is held in the electrode group.

The positive electrode 3 includes a positive electrode current collector 3a and a positive electrode active material-containing layer 3b. The positive electrode active material-containing layer 3b contains a positive electrode active material. The positive electrode active material-containing layer 3b is formed on both surfaces of the positive electrode current collector 3a. The negative electrode 4 includes a negative electrode current collector 4a and a negative electrode active material-containing layer 4b. The negative electrode active material-containing layer 4b contains a negative electrode active material. In a portion of the negative electrode 4 located on the outermost side, the negative electrode active material-containing layer 4b is formed only on one surface on an inner surface side of the negative electrode current collector 4a. For the other portions of the negative electrode 4, the negative electrode active material-containing layers 4b are formed on both surfaces of the negative electrode current collector 4a.

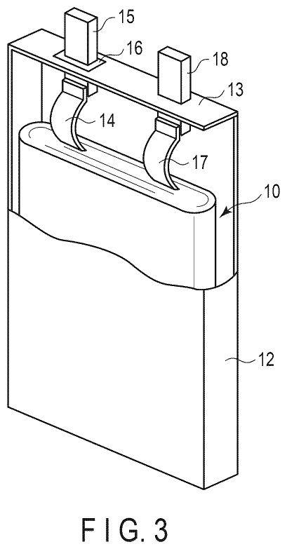

As illustrated in FIG. 1, the positive electrode terminal 7 is electrically connected to the positive electrode 3 in the vicinity of the outer peripheral end of the electrode group 1. In addition, the negative electrode terminal 6 is electrically connected to the negative electrode 4 in the portion of the outermost layer. The positive electrode terminal 7 and the negative electrode terminal 6 extend outside through an opening of the container member 2. The battery is not limited to those having the configuration as illustrated in FIGS. 1 and 2 described above, and may have, for example, the configuration illustrated in FIG. 3.

In the rectangular battery illustrated in FIG. 3, the electrode group 10 is housed in a bottomed rectangular cylindrical container 12 made of metal as a container member. A rectangular lid body 13 is welded to an opening of the container 12. The flat electrode group 10 can have, for example, the same configuration as the electrode group 1 described with reference to FIGS. 1 and 2.

One end of a negative electrode lead 14 is electrically connected to the negative electrode current collector, and the other end thereof is electrically connected to a negative electrode terminal 15. The negative electrode terminal 15 is fixed to the rectangular lid body 13 by hermetic sealing with a glass material 16 interposed therebetween. One end of a positive electrode lead 17 is electrically connected to the positive electrode current collector, and the other end thereof is electrically connected to the positive electrode terminal 18 fixed to the rectangular lid body 13.

The negative electrode lead 14 is made of, for example, a material such as aluminum or an aluminum alloy containing an element such as Mg, Ti, Zn, Mn, Fe, Cu, or Si. The negative electrode lead 14 is preferably made of the same material as the negative electrode current collector, in order to reduce contact resistance between the negative electrode lead and the negative electrode current collector.

The positive electrode lead 17 is made of, for example, a material such as aluminum or an aluminum alloy containing an element such as Mg, Ti, Zn, Mn, Fe, Cu, or Si. The positive electrode lead 17 is preferably made of the same material as the positive electrode current collector, in order to reduce contact resistance between the positive electrode lead and the positive electrode current collector.

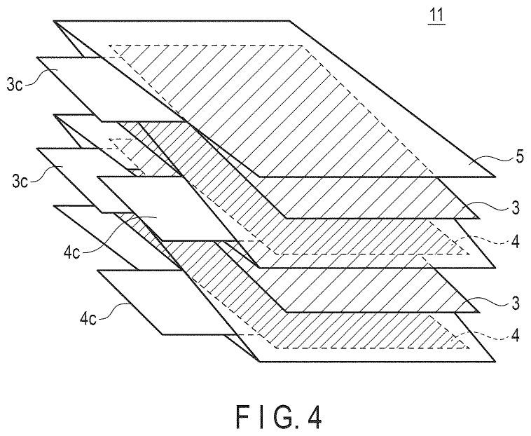

In the battery illustrated in FIG. 3, a wound-type electrode group (wound electrode group) in which a separator is wound together with a positive electrode and a negative electrode is used, but a stacked-type electrode group (stacked electrode group) may be used as the electrode group 10 instead of the wound electrode group. An example of such a stacked electrode group is illustrated in FIG. 4. The electrode group 11 illustrated in FIG. 4 is configured by folding the separator 5 zigzag and alternately disposing the positive electrode 3 and the negative electrode 4 at the folded portions. Specifically, the positive electrode 3, the negative electrode 4, the positive electrode 3, and the negative electrode 4 are disposed in this order so as to be sandwiched between the separators 5 in the separator 5 folded zigzag. The positive electrode current-collecting tab 3c and the negative electrode current-collecting tab 4c protrude from one long side portion of the separator 5 folded zigzag. The positive electrode current-collecting tab 3c and the negative electrode current-collecting tab 4c are disposed so as not to overlap each other.

The order of the positive electrode 3 and the negative electrode 4 is not limited to the order illustrated in FIG. 4, and the negative electrode 4, the positive electrode 3, the negative electrode 4, and the positive electrode 3 may be disposed in this order.

When the stacked electrode group 11 described above with reference to FIG. 4 is applied as the electrode group 10 included in the battery illustrated in FIG. 3, each of a plurality of the positive electrode current-collecting tabs 3c can be electrically connected to the positive electrode lead 17. In addition, each of a plurality of the negative electrode current-collecting tabs 4c can be electrically connected to the negative electrode lead 14.

### (Manufacturing Method)

An example of a method for manufacturing the battery according to the embodiment includes: providing a positive electrode and a negative electrode; housing the positive electrode and the negative electrode in a container member; injecting an electrolyte into the container member; sealing the container member to obtain a battery precursor; and performing aging on the battery precursor to obtain a battery. The battery precursor may be initially charged before aging. After aging, the gas in the battery may be removed.

The positive electrode can be produced, for example, by the following method. First, a positive electrode active material, an electro-conductive agent, and a binder are suspended in a solvent to prepare a slurry. The slurry is applied onto one side or both sides of a positive electrode current collector. Then, the applied slurry is dried to obtain a stack of a positive electrode active material-containing layer and the positive electrode current collector. Then, the stack is subjected to pressing. The positive electrode is produced in this manner.

Alternatively, the positive electrode may be produced by the following method. First, a positive electrode active material, an electro-conductive agent, and a binder are mixed to obtain a mixture. Next, the mixture is formed into pellets. The positive electrode can then be obtained by disposing these pellets on the positive electrode current collector.

The negative electrode can be produced, for example, by the following method. First, a negative electrode active material, an electro-conductive agent, and a binder are suspended in a solvent to prepare a slurry. The slurry is applied onto one side or both sides of a negative electrode current collector. Then, the applied slurry is dried to obtain a stack of a negative electrode active material-containing layer and the negative electrode current collector. Then, the stack is subjected to pressing. The negative electrode is produced in this manner.

Alternatively, the negative electrode may be produced by the following method. First, a negative electrode active material, an electro-conductive agent, and a binder are mixed to obtain a mixture. Next, the mixture is formed into pellets. Then, the negative electrode can be obtained by disposing the pellets onto the negative electrode current collector.

An electrode group can be produced by disposing a separator between the positive electrode and the negative electrode produced as described above. In the electrode group, a positive electrode terminal can be electrically connected to the positive electrode, and a negative electrode terminal can be electrically connected to the negative electrode.

The electrode group having the positive and negative electrode terminals is housed in a bag-shaped container member made of a laminate film, and then a portion other than an opening for injecting an electrolyte is sealed through thermal fusion (heat sealing) while leaving the opening. Next, an electrolyte is injected into the bag-shaped container member through the opening, and the opening is sealed through thermal fusion. The thermal fusion may be carried out under reduced pressure. Thus, a battery precursor is obtained.

Next, aging is performed on the battery precursor at room temperature or higher. Before aging, an initial charge may be performed at room temperature (e.g., 25° C.). The aging may be performed after discharge is performed after the initial charge.

The electrolyte is decomposed as the battery precursor undergoes aging, and as a result, a coating can be formed on at least a part of the surfaces of the positive electrode and the negative electrode. Specifically, for example, a decomposition product generated by the decomposition of the electrolyte by the reaction between the positive electrode and/or the negative electrode and the electrolyte can adhere to at least a part of the surfaces of the positive electrode and the negative electrode to form a coating. The decomposition of the electrolyte and the formation of the coating can also occur during the initial charge.

Specifically, in the positive electrode, a coating can be formed on at least a part of the surface of the first oxide. As a result, the proportion of the first oxide on the surface of the positive electrode may decrease. Therefore, the ratio B/A in HAXPES for the surface of the positive electrode can be set to 0.07 or more and 0.20 or less. In the negative electrode, a coating can be formed on at least a part of the surface of the lithium titanium-containing oxide. As a result, the proportion of the lithium titanium-containing oxide on the surface of the negative electrode may decrease. Therefore, the ratio D/C can be set to 0.75 or more and 1.8 or less.

Details of manufacturing conditions will be described below.

The aging can be performed, for example, on the battery precursor in an environment at a temperature of 40° C. or higher and 80° C. or lower for a time of 12 hours or more and 100 hours or less. Before aging, it is preferable to perform the aging after setting a battery voltage to be in a range of 2.05 V or more and 2.3 V or less by initial charge or discharge after the initial charge.

As the temperature at the time of the aging is increased or the aging time is increased, the decomposition of the electrolyte tends to proceed more easily. In addition, as the battery voltage when the battery precursor is subjected to aging is increased, the decomposition of the electrolyte tends to proceed.

Although details will be described later, the electrolyte may contain a substance containing a lithium atom and a fluorine atom. The substance containing a lithium atom and a fluorine atom is decomposed at the time of aging, whereby a coating containing lithium fluoride is easily formed on the positive electrode and/or the negative electrode.

Hereinafter, the negative electrode, the positive electrode, and the electrolyte will be described. The separator, the container member, the positive electrode terminal, and the negative electrode terminal which can be included in the battery of the embodiment in addition to these members will also be described below.

### (Negative Electrode)

The negative electrode can include a negative electrode current collector and a negative electrode active material-containing layer. The negative electrode active material-containing layer can be formed on one side or both sides of the negative electrode current collector. The negative electrode active material-containing layer can include a negative electrode active material, and optionally an electro-conductive agent and a binder. The lithium titanium-containing oxide can be contained, for example, in the negative electrode as a negative electrode active material.

Since the negative electrode included in the battery according to the embodiment contains a lithium titanium-containing oxide, a lithium insertion potential can be increased. The higher the lithium insertion potential of the negative electrode is, the more easily the decomposition of the electrolyte is suppressed, which is preferable. The negative electrode preferably exhibits a Li insertion potential of 1.5 V (vs. Li/Li⁺) or more as a value with respect to an oxidation-reduction potential of lithium.

A coating can be formed on at least a part of the surface of the negative electrode. The coating may contain, for example, a fluorine atom. The fluorine atom can be contained in the coating, for example, as lithium fluoride (LiF). The coating may be present on at least a part of the surface of the negative electrode active material-containing layer, or may cover at least a part of the surfaces of the negative electrode active material particles. The coating is a film or a layer.

The negative electrode included in the battery according to the embodiment may be changed from the negative electrode immediately after production. In other words, it can be changed from the negative electrode included in the battery precursor before being subjected to the initial charge and aging. This is because, for example, the negative electrode and the electrolyte may react during the initial charge and/or aging after assembling the battery precursor as described above. In this reaction, a coating can be formed on at least a part of the surface of the negative electrode.

A density of the negative electrode active material-containing layer (excluding the negative electrode current collector) is preferably from 1.8 g/cm³ or more and 2.8 g/cm³ or less. A negative electrode including the negative electrode active material-containing layer having a density within this range is excellent in energy density and electrolyte retention. The density of the negative electrode active material-containing layer is more preferably 2.1 g/cm³ or more and 2.6 g/cm³ or less.

The negative electrode active material may contain a lithium titanium-containing oxide alone, or may further contain another active material. From the viewpoint of suppressing excessive decrease in negative electrode potential, the negative electrode active material preferably contains the lithium titanium-containing oxide in an amount of 70 mass % or more, and more preferably 80 mass % or more. An upper limit of the proportion of the lithium titanium-containing oxide in the negative electrode active material can be set to 100 mass %.

Examples of the lithium titanium-containing oxide include lithium titanate having a ramsdellite structure (for example, Li_{2+y}Ti₃O₇, 0≤y≤3) and lithium titanate having a spinel structure (for example, Li₄₊ₓTi₅O₁₂, 0<x≤3). The type of the lithium titanium-containing oxide can be one or two or more.

Examples of an active material other than the lithium titanium-containing oxide include titanium dioxide (TiO₂), anatase titanium dioxide, rutile titanium dioxide, niobium pentoxide (Nb₂O₅), hollandite titanium composite oxide, orthorhombic titanium composite oxide, and monoclinic niobium-titanium oxide. The type of the other active material can be one or two or more.

Examples of the orthorhombic titanium-containing composite oxide as described above include a compound represented by Li₂₊ₐM^{I}_{2-b}Ti_{6-c}M^{II}_{d}O_{14+σ}. Here, M^{I} is at least one selected from the group consisting of Sr, Ba, Ca, Mg, Na, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are as follows: 0≤a≤6, 0≤b<2, 0≤c<6, 0≤d<6, and −0.5 σ≤0.5. A specific example of the orthorhombic titanium-containing composite oxide is Li₂₊ₐNa₂Ti₆O₁₄ (0≤a≤6).

An example of the monoclinic niobium-titanium oxide is a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formula are as follows: 0≤x≤5, 0≤y<1, 0≤z<2, and −0.3≤δ≤0.3. A specific example of the monoclinic niobium-titanium oxide is LiₓNb₂TiO₇ (0≤x≤5).

Another example of the monoclinic niobium-titanium oxide is a compound represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formula are as follows: 0≤x≤5, 0≤y<1, 0≤z<2, and −0.3≤δ≤0.3.

The electro-conductive agent is added to improve current collection performance and to suppress the contact resistance between the negative electrode active material and the negative electrode current collector. Examples of the electro-conductive agent include carbonaceous substances such as vapor grown carbon fiber (VGCF), carbon blacks such as acetylene black, graphite, carbon nanotubes, and carbon nanofibers. One of these may be used as the electro-conductive agent, or two or more may be used in combination as the electro-conductive agent. Alternatively, instead of using the electro-conductive agent, a carbon coat or an electronically conductive inorganic material coat may be applied to the surfaces of the negative electrode active material particles.

The binder is blended in order to fill the gaps between the dispersed negative electrode active materials and to bind the negative electrode active material and the negative electrode current collector. Examples of the binder include polytetrafluoroethylene (PTFE), polyvinylidene fluoride (PVdF), fluorine rubber, styrene-butadiene rubber, polyacrylic acid compounds, imide compounds, carboxymethyl cellulose (CMC), and salts of CMC. One of these may be used as the binder, or alternatively, two or more may be used in combination as the binder.

In the negative electrode active material-containing layer, it is preferable to blend the negative electrode active material, the electro-conductive agent and the binder in proportions of 68 mass % or more and 96 mass % or less, 2 mass % or more and 30 mass % or less, and 2 mass % or more and 30 mass % or less, respectively. The amount of the electro-conductive agent is set to 2 mass % or more, so that current collecting performance of the negative electrode active material-containing layer can be improved. Further, the amount of the binder is set to 2 mass % or more, so that binding property between the negative electrode active material-containing layer and the negative electrode current collector becomes sufficient, and excellent cycle performance can be expected. On the other hand, an amount of each of the electro-conductive agent and binder is preferably 30 mass % or less, in view of increasing the capacity.

There may be used for the negative electrode current collector, a material which is electrochemically stable at a potential at which lithium (Li) is inserted into and extracted from the negative electrode active material. For example, the negative electrode current collector is preferably made of copper, nickel, stainless steel or aluminum, or an aluminum alloy including one or more elements selected from Mg, Ti, Zn, Mn, Fe, Cu, and Si. A thickness of the negative electrode current collector is preferably 5 μm or more and 20 μm or less. The negative electrode current collector having such a thickness can achieve a balance between strength and weight reduction of the negative electrode.

Further, the negative electrode current collector can include a portion where the negative electrode active material-containing layer is not formed on the surface thereof. This portion can serve as a negative electrode current-collecting tab.

### (Positive Electrode)

The positive electrode can include a positive electrode current collector and a positive electrode active material-containing layer. The positive electrode active material-containing layer may be formed on one side or both sides of the positive electrode current collector. The positive electrode active material-containing layer can include a positive electrode active material, and optionally an electro-conductive agent and a binder.

A coating can be formed on at least a part of the surface of the positive electrode. The coating may contain, for example, a fluorine atom. The fluorine atom can be contained in the coating, for example, as lithium fluoride (LiF). The coating may be present on at least a part of the surface of the positive electrode active material-containing layer, or may cover at least a part of the surfaces of the positive electrode active material particles. The coating is a film or a layer.

The positive electrode included in the battery according to the embodiment may be changed from the positive electrode immediately after production. In other words, it can be changed from the positive electrode included in the battery precursor before being subjected to the initial charge and aging. This is because, for example, the positive electrode and the electrolyte may react during the initial charge and/or aging after assembling the battery precursor as described above. In this reaction, a coating can be formed on at least a part of the surface of the positive electrode.

The positive electrode active material may contain the first oxide described above alone, or may further contain another negative electrode active material. From the viewpoint of increasing the battery capacity, the positive electrode active material preferably contains the first oxide in an amount of 80 mass % or more, and more preferably 90 mass % or more. An upper limit of the proportion of the first oxide in the positive electrode active material can be set to 100 mass %.

As the positive electrode active material other than the first oxide, for example, a sulfide or an oxide other than the first oxide can be used. Examples of the sulfide and oxide include compounds capable of allowing Li or Li ions to be inserted and extracted.

Examples of such compounds include manganese dioxide (MnO₂), iron oxides, copper oxides, nickel oxides, lithium-manganese composite oxides (e.g., LiₓMn₂O₄ or LiₓMnO₂; 0<x≤1), lithium-nickel composite oxides (e.g., LiₓNiO₂; 0<x≤1), lithium-cobalt composite oxides (e.g., LiₓCoO₂; 0<x≤1), lithium-nickel-cobalt composite oxides (e.g., LiₓNi_{1-y}Co_{y}O₂; 0<x≤1, 0<y<1), lithium-manganese-cobalt composite oxides (e.g., LiₓMn_{y}Co_{1-y}O₂; 0<x≤1, 0<y<1), lithium-manganese-nickel composite oxides having a spinel structure (e.g., LiₓMn_{2-y}Ni_{y}O₄; 0<x≤1, 0<y<2), lithium-phosphorus oxides having an olivine structure (e.g., LiₓFePO₄; 0<x≤1, LiₓFe_{1-y}Mn_{y}PO₄; 0<x≤1, 0<y≤1, and LiₓCoPO₄; 0<x≤1), iron sulfate (Fe₂(SO₄)₃), and vanadium oxides (e.g., V₂O₅), and lithium-nickel-cobalt-manganese composite oxide having an A_{Ni} of less than 0.7. More specific examples include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese nickel composite oxides having a spinel structure (e.g., LiₓMn_{2-y}Ni_{y}O₄; 0<x 1, 0<y<2), lithium manganese cobalt composite oxide (e.g., LiₓMn_{y}Co_{1-y}O₂; 0<x≤1, 0<y<1), lithium iron phosphates (e.g., LiₓFePO₄; 0<x≤1), and lithium-nickel-cobalt-manganese composite oxide having an A_{Ni} of less than 0.7 (LiₓNi_{1-y-z}Co_{y}Mn_{z}O₂; 0<x≤1, 0<y<1, 0<z<1, 0.3<y+z<1).

The binder is blended to fill gaps among the dispersed positive electrode active material and also to bind the positive electrode active material with the positive electrode current collector. Examples of the binder include polytetrafluoro ethylene (PTFE), polyvinylidene fluoride (PVdF), fluororubber, polyacrylic acid compounds, imide compounds, carboxymethyl cellulose (CMC), and salts of CMC. One of these may be used as the binder, or alternatively, two or more may be used in combination as the binder.

The electro-conductive agent is blended to improve current collection performance and to suppress contact resistance between the positive electrode active material and the positive electrode current collector. Examples of the electro-conductive agent include carbonaceous materials such as vapor grown carbon fiber (VGCF), carbon black such as acetylene black, and graphite. One of these may be used as the electro-conductive agent, or two or more may be used in combination as the electro-conductive agent. The electro-conductive agent may not be used.

In the positive electrode active material-containing layer, the positive electrode active material and the binder are preferably blended in proportions of 80 mass % or more and 98 mass % or less, and 2 mass % or more and 20 mass % or less, respectively.

Due to the amount of the binder of 2 mass % or more, sufficient electrode strength can be achieved. The binder may function as an electrical insulator. Thus, in a case where the amount of the binder is 20 mass % or less, the amount of electrical insulator in the electrode is reduced, and thus internal resistance can be decreased.

In a case where the electro-conductive agent is added, the positive electrode active material, the binder, and the electro-conductive agent are preferably blended in proportions of 77 mass % or more and 95 mass % or less, 2 mass % or more and 20 mass % or less, and 3 mass % or more and 15 mass % or less, respectively.

Due to the amount of the electro-conductive agent of 3 mass % or more, the above-described effects can be exhibited. Due to the amount of the electro-conductive agent of 15 mass % or less, the proportion of electro-conductive agent to be contacted with the electrolyte can be reduced. In a case where this proportion is low, decomposition of the electrolyte can be reduced during storage at high temperatures.

The positive electrode current collector is preferably an aluminum foil, or an aluminum alloy foil including one or more selected from the group consisting of Mg, Ti, Zn, Ni, Cr, Mn, Fe, Cu, and Si.

A thickness of the aluminum foil or aluminum alloy foil is preferably 5 μm or more and 20 μm or less, and more preferably 15 μm or less. A purity of the aluminum foil is preferably 99 mass % or more. Contents of transition metals such as iron, copper, nickel, and chromium included in the aluminum foil or aluminum alloy foil are preferably 1 mass % or less.

The positive electrode current collector can include a portion where the positive electrode active material-containing layer is not formed, on a surface thereof. This portion can serve as a positive electrode current-collecting tab.

### (Electrolyte)

As the electrolyte, for example, a nonaqueous electrolyte can be used. The composition of the electrolyte included in the battery of the embodiment may be changed from the composition (initial composition) of the electrolyte immediately after preparation. This is because, for example, a substance contained in the electrolyte can be decomposed during aging or the like after assembling the battery precursor using the electrolyte immediately after preparation.

As the nonaqueous electrolyte, for example, a liquid nonaqueous electrolyte or a gel nonaqueous electrolyte can be used.

The liquid nonaqueous electrolyte is prepared by dissolving an electrolyte salt as a solute in an organic solvent.

The carboxylic acid ester and the cyclic carbonate can be contained in the electrolyte as an organic solvent. The organic solvent may further contain a solvent other than the carboxylic acid ester and the cyclic carbonate.

As the carboxylic acid ester, those of the type described above can be used. The type of the carboxylic acid ester contained in the electrolyte can be one or two or more.

Examples of the cyclic carbonate include ethylenecarbonate (EC), propylene carbonate (PC) and vinylene carbonate (VC). The type of the cyclic carbonate can be one or two or more.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂), and mixtures thereof. The electrolyte salt is preferably hard to oxidize even at a high potential, and is most preferably LiPF₆.

A concentration of the electrolyte salt is preferably 0.5 mol/L or more and 2.5 mol/L or less.

Examples of the solvent other than the carboxylic acid ester and the cyclic carbonate include chain carbonates such as dimethyl carbonate (DMC), ethyl methyl carbonate (EMC), and diethyl carbonate (DEC); cyclic ethers such as tetrahydrofuran (THF) and 2-methyl tetrahydrofuran (2MeTHF); linear ethers such as dimethoxyethane (DME); cyclic esters such as γ-butyrolactone (BL); acetonitrile (AN); and nonaqueous solvents such as sulfolane (SL). These nonaqueous solvents can be used alone or in the form of a mixture of two or more.

The electrolyte preferably contains a substance containing a lithium atom and a fluorine atom. The substance containing a lithium atom and a fluorine atom may have a function as the electrolyte salt or the organic solvent, and may also serve as the electrolyte salt and the organic solvent.

The substance containing a lithium atom and a fluorine atom preferably does not have a function as the electrolyte salt. That is, the electrolyte preferably contains a substance containing a lithium atom and a fluorine atom in addition to the electrolyte salt. When the electrolyte contains such a substance, decomposition of the electrolyte salt can be suppressed. As a result, it is possible to suppress formation of an excessive coating on the positive electrode and/or the negative electrode. Examples of the substance containing a lithium atom and a fluorine atom, which does not have a function as the electrolyte salt, include lithium phosphorodifluoridate (DFP) and lithium difluoro bis oxalato phosphate (LiDFBOP). The type of the substance containing a lithium atom and a fluorine atom can be one or two or more.

When the electrolyte contains a large amount of the substance containing a lithium atom and a fluorine atom, the amount of the coating formed on the positive electrode and the negative electrode may be increased. From the viewpoint of setting the ratio B/A in HAXPES for the surface of the positive electrode to 0.07 or more and 0.20 or less and setting the ratio D/C in HAXPES for the surface of the negative electrode to 0.75 or more and 1.8 or less, the electrolyte preferably contains 0.1 mass % or more and 5 mass % or less of DFP and 0.1 mass % or more and 5 mass % or less of LiDFBOP.

As the electrolyte contains a larger amount of LiDFBOP, the amount of the coating formed on the negative electrode tends to increase.

LiDFBOP can suppress decomposition of the electrolyte salt and can form a coating by decomposition of LiDFBOP itself. Therefore, as the electrolyte contains a larger amount of LiDFBOP, the amount of the coating formed on the negative electrode tends to be able to be increased. Therefore, when the electrolyte contains LiDFBOP, the amount of the coating formed on the negative electrode is easily controlled within a preferable range, which is preferable.

The gel nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

### (Separator)

The separator may be made of, for example, a porous film or synthetic resin nonwoven fabric including polyethylene (PE), polypropylene (PP), cellulose, or polyvinylidene fluoride (PVdF). In view of safety, a porous film made of polyethylene or polypropylene is preferred. This is because, at a certain temperature, such a porous film melts and can shut off current.

### (Container Member)

The container member may be formed of a laminate film or a metal container. When a metal container is used, a lid can be integrated with or separated from the container. A thickness of the metal container is more preferably 0.5 mm or less and 0.2 mm or less. Examples of the shape of the container member include a flat type, a rectangular type, a cylindrical type, a coin type, a button type, a sheet type, and a stacked type. The container member may be a container member for a small battery mounted in a portable electronic device or the like, or may be a container member for a large battery mounted in a two-wheeled or four-wheel automobile.

A thickness of the laminate film container member is desirably 0.2 mm or less. Examples of the laminate film include a multilayer film including a resin film and a metal layer disposed between the resin films. The metal layer is preferably an aluminum foil or an aluminum alloy foil, in order to reduce weight. The resin film can be, for example, a polymer material such as polypropylene (PP), polyethylene (PE), nylon, or polyethylene terephthalate (PET). The laminate film can be formed into a shape of a container member by performing sealing through thermal fusion.

The metal container is made of aluminum, an aluminum alloy, or the like. The aluminum alloy is preferably an alloy containing an element such as magnesium, zinc, or silicon. In aluminum or an aluminum alloy, the content of the transition metal such as iron, copper, nickel, or chromium is preferably 100 ppm or less in order to dramatically improve long-term reliability and heat dissipation in a high-temperature environment.

The metal container made of aluminum or an aluminum alloy desirably has an average crystal grain size of 50 μm or less, more preferably 30 μm or less, and even more preferably 5 μm or less. By setting the average crystal grain size to 50 μm or less, the strength of the metal container made of aluminum or an aluminum alloy can be dramatically increased, and the container can be further thinned. As a result, it is possible to realize a battery that is lightweight, has high output, and is excellent in long-term reliability, and is suitable for an in-vehicle application and the like.

### (Negative Electrode Terminal and Positive Electrode Terminal)

A part of the negative electrode terminal is electrically connected to a part of the negative electrode, so that the negative electrode terminal can act as a conductor for electrons to move between the negative electrode and the external terminal. The negative electrode terminal can be connected to, for example, a negative electrode current collector, in particular, a negative electrode tab. Similarly, a part of the positive electrode terminal is electrically connected to a part of the positive electrode, so that the positive electrode terminal can act as a conductor for electrons to move between the positive electrode and the external circuit. The positive electrode terminal can be connected to, for example, a positive electrode current collector, in particular, a positive electrode tab. The negative electrode terminal and the positive electrode terminal are preferably made of a material having high electrical conductivity. In the case of being connected to the current collectors, these terminals are preferably made of the same material as the current collectors in order to reduce contact resistance.

### (Measurement Method)

Hereinafter, the HAXPES for the electrode surface, composition analysis of the electrolyte, composition analysis of the active material, measurement of the average particle size and particle size distribution, and a method of measuring the breaking strength of the active material particles will be described.

First, a method of extracting an electrode from a battery to be measured before various analyses will be described.

### (Method of Extracting Electrode)

First, the battery is discharged. For example, the battery is discharged until the battery voltage reaches 1.5 V. Thereafter, the battery is disassembled in an argon (Ar) atmosphere, and the electrode group is extracted. An electrode to be analyzed is cut out from the extracted electrode group. For example, the positive electrode is cut out when analysis is performed on the positive electrode, and the negative electrode is cut out when analysis is performed on the negative electrode. The cut-out electrode is washed with an appropriate solvent. As the solvent, for example, ethyl methyl carbonate can be used. The washed electrode is immersed in a solvent for 1 hour, and then dried in a reduced-pressure environment of −90 kPa for 3 hours. Thus, an electrode as a measurement sample is obtained.

### (Analysis of Electrode Surface by HAXPES)

Hard X-ray photoelectron spectroscopy (HAXPES) can be used as a method for analyzing the surfaces of the positive electrode and the negative electrode.

The surface of the electrode as a measurement sample is measured under vacuum by a beamline including a hard X-ray photoelectron spectrometer. Measurement conditions are an excitation energy of 6 keV, a photoelectron detection angle of about 88°, and an energy step of about 0.1 eV.

An analysis method of the HAXPES spectrum obtained as described above will be described below separately for the analysis of the positive electrode and the analysis of the negative electrode.

### (Analysis of HAXPES Spectrum of Positive Electrode)

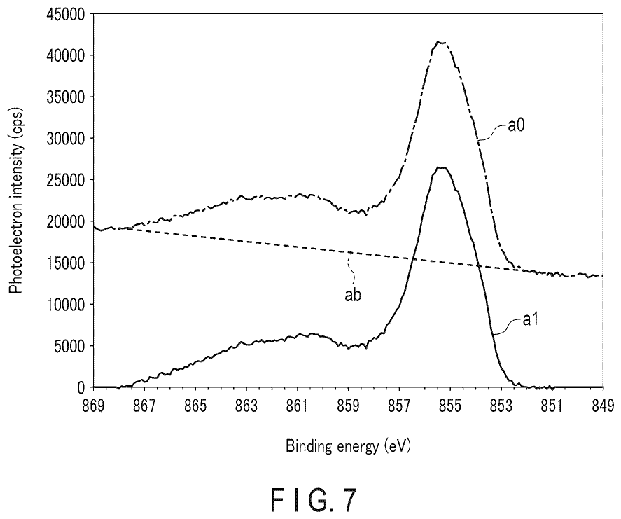

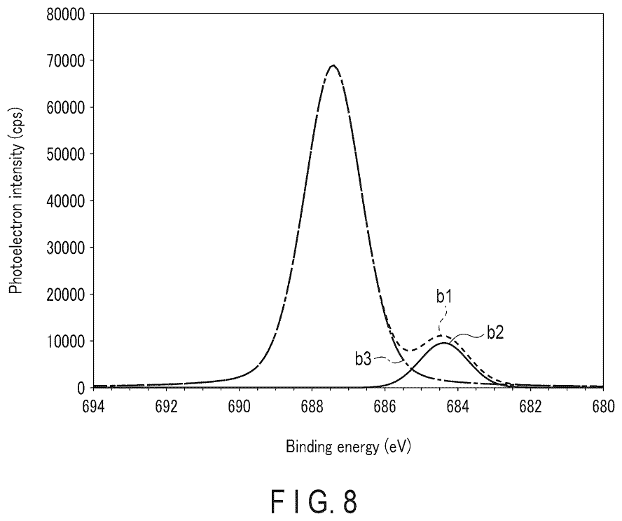

A method for measuring the area A and the area B by analyzing the HAXPES spectrum obtained for the surface of the positive electrode will be described below with reference to FIGS. 7 and 8. FIGS. 7 and 8 illustrate, as an example of the positive electrode included in the battery according to the embodiment, a HAXPES spectrum obtained for a positive electrode included in a battery of Example 2 described later. Hereinafter, in the HAXPES spectrum, the horizontal axis represents binding energy (Binding Energy, unit: eV), and the vertical axis represents photoelectron intensity (Photoelectron Intensity, unit: cps (counts per second)).

First, a method of calculating the area A of the peak having a peak top in the range of 851 eV or more and 868 eV or less will be described with reference to FIG. 7. In FIG. 7, a part of the HAXPES spectrum obtained for the positive electrode included in Example 2 is indicated by the symbol a0. A background of the spectrum a0 is indicated by the symbol ab.

The background is a straight line passing through the right end and the left end of a target range (subtraction range) of background subtraction in the spectrum. For example, when the area A is calculated, the right end of the subtraction range is 851 eV, and the left end is 868 eV. Photoelectron intensities at the right end and the left end are average values in a range of ±0.5 eV at the right end and the left end, respectively.

The background ab is subtracted from the spectrum a0 to obtain a chart al. By integrating the intensity of the chart al in the range of 851 eV or more and 868 eV or less as an integration range, the area A of the peak having a peak top in the range of 851 eV or more and 868 eV or less can be calculated.

Next, a method of calculating the area B will be described with reference to FIG. 8. When the area B is calculated, the subtraction range is 681 eV or more and 694 eV or less. In FIG. 8, a chart obtained by subtracting the background with the subtraction range set to 681 eV or more and 694 eV or less is illustrated as b1.

The chart b1 is separated for each peak. Specifically, fitting is performed, assuming that the chart b1 includes a first peak that is a Gaussian function shape having a maximum value (peak top) in the range of 683 eV or more and 686 eV or less, and a second peak that is a pseudo-Voigt function shape. By fitting, the chart b1 is separated into a chart b2 including the first peak and a chart b3 including the second peak. Thus, the chart b2 including the first peak having the maximum value (peak top) in the range of 683 eV or more and 686 eV or less can be obtained.

By integrating the intensity of chart b2 in the range of 680 eV or more and 694 eV or less as an integration range, the area B of the peak having a peak top in the range of 683 eV or more and 686 eV or less can be calculated.

The ratio B/A can be obtained by dividing the area B obtained as described above by the area A. In the positive electrode included in Example 2 illustrated in FIGS. 7 and 8, the area A was 1193741, the area B was 158801, and the ratio B/A was 0.13.

### (Analysis of HAXPES Spectrum of Negative Electrode)

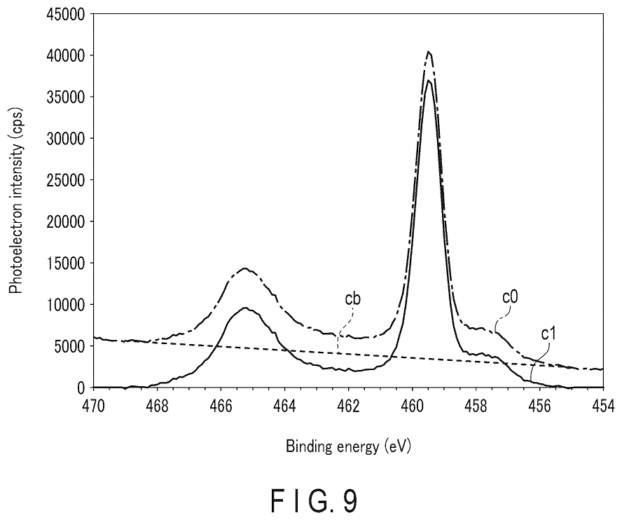

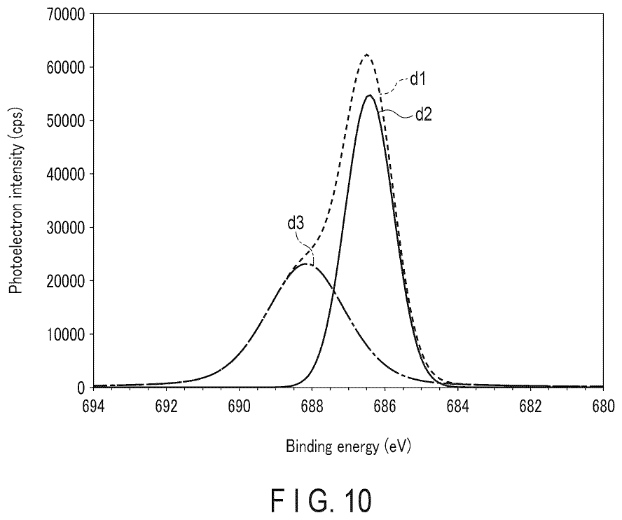

A method for measuring the area C and the area D by analyzing the HAXPES spectrum obtained for the surface of the negative electrode will be described below with reference to FIGS. 9 and 10. FIGS. 9 and 10 illustrate, as an example of the negative electrode included in the battery according to the embodiment, a HAXPES spectrum obtained for a negative electrode included in a battery of Example 2 described later.

First, a method of calculating the area C of the peak having a peak top in the range of 455 eV or more and 469 eV or less will be described with reference to FIG. 9. In FIG. 9, a part of the HAXPES spectrum obtained for the negative electrode included in Example 2 is indicated by the symbol c0. A background of the spectrum c0 is indicated by the symbol cb. The background is set in the range of 455 eV or more and 469 eV or less as a subtraction range. The background cb is subtracted from the spectrum c0 to obtain a chart c1. By integrating the intensity of the chart c1 in the range of 455 eV or more and 469 eV or less as an integration range, the area C of the peak having a peak top in the range of 455 eV or more and 469 eV or less can be calculated.

Next, a method of calculating the area D will be described with reference to FIG. 10. When the area D is calculated, the subtraction range is 681 eV or more and 694 eV or less. In FIG. 10, a chart obtained by subtracting the background with the subtraction range set to 681 eV or more and 694 eV or less is illustrated as d1.

The chart d1 is separated for each peak. Specifically, fitting is performed, assuming that the chart d1 includes a first peak that is a Gaussian function shape having a maximum value (peak top) in the range of 685 eV or more and 687.5 eV or less, and a second peak that is a pseudo-Voigt function shape. By fitting, the chart d1 is separated into a chart d2 including the first peak and a chart d3 including the second peak. Thus, the chart d2 including the first peak having the maximum value (peak top) in the range of 685 eV or more and 687.5 eV or less can be obtained.

By integrating the intensity of chart d2 in the range of 680 eV or more and 694 eV or less as an integration range, the area D of the peak having a peak top in the range of 685 eV or more and 687.5 eV or less can be calculated.

The ratio D/C can be obtained by dividing the area D obtained as described above by the area C. In the negative electrode included in Example 2 illustrated in FIGS. 9 and 10, the area C was 758510.8, the area D was 908960.0, and the ratio D/C was 1.2.

### (Composition Analysis of Electrolyte)

The composition of the electrolyte can be measured by gas chromatography-mass spectrometry (GC-MS). For example, the volumes of the carboxylic acid ester and the cyclic carbonate contained in the electrolyte can be specified by GC-MS.

First, the battery to be measured is disassembled to extract an electrolyte. The extracted electrolyte is analyzed by gas chromatography-mass spectrometry and ion chromatography. By this analysis, components (solvent and solute) contained in a nonaqueous electrolytic solution can be identified. In addition, each of the components can be quantified from the peak area of the chart obtained by this analysis. From the quantitative value, the ratio between the components is calculated.

### (Composition Analysis of Active Material)

The composition of the active material contained in the electrode can be measured by powder X-ray diffraction (XRD) described below. That is, it can be specified that the positive electrode contains the first oxide and the negative electrode contains the lithium titanium-containing oxide.

The active material-containing layer is peeled off from the electrode as the measurement sample using, for example, a spatula to obtain a powdery sample.

A crystal structure of the active material is identified by powder X-ray diffraction (XRD) measurement on the powdery sample. The measurement is performed in a measurement range in which 2θ is 10° or more and 90° or less using a CuKα ray as a radiation source. By this measurement, the X-ray diffraction pattern of the compound contained in the selected particles can be obtained.

As an apparatus for powder X-ray diffraction measurement, SmartLab manufactured by Rigaku Corporation, for example, is used. The measurement conditions are as follows:
X-ray source: Cu target
Output: 45 kV, 200 mA
Soller slit: 5° for both incident light and received light
Step width: 0.02 deg
Scan speed: 20 deg/min
Semiconductor detector: D/teX Ultra 250
Sample plate holder: flat glass sample plate holder (thickness: 0.5 mm)
Measurement range: range of 10°≤2θ≤90°.

When any other apparatus is used, measurement is performed using standard Si powder for powder X-ray diffraction so that the equivalent measurement results as above can be obtained, and the conditions are adjusted so that the peak intensity and peak top position match those of the apparatus. Then, measurement is made.

### (Measurement of Average Particle Size and Particle Size Distribution)

The average particle size and particle size distribution of the active material contained in the electrode can be measured by a laser diffraction/scattering method which will be described below.

In the electrode as the measurement sample, the active material-containing layer is separated from the current collector using, for example, a spatula to obtain a powdery sample containing active material particles. Then, a powdery sample is charged into a measurement cell filled with N-methylpyrrolidone (NMP) until the concentration reaches a measurable concentration. The capacity of the measurement cell and the measurable concentration differ depending on the particle size distribution measuring apparatus. The measurement cell containing NMP and the sample dissolved therein is irradiated with ultrasonic waves for 5 minutes. The output of ultrasonic wave is, for example, in a range of 35 W to 45 W. For example, when NMP is used as the solvent in an amount of about 50 ml, the solvent mixed with the measurement sample is irradiated with ultrasonic waves having an output of about 40 W for 300 seconds. By such ultrasonic irradiation, the aggregation between the electro-conductive agent particles and the active material particles can be released. The measurement cell is inserted into a particle size distribution measuring apparatus by the laser diffraction scattering method, and the particle size distribution is measured. Examples of the particle size distribution measuring apparatus include Microtrac3100 and Microtrac3000II (both manufactured by MicrotracBEL Corp.), or an apparatus having a function equivalent thereto. Thus, the particle size distribution of the electrode can be obtained.

The particle size distribution obtained by the above method is a volume-based cumulative frequency distribution that is accumulated in order from a small particle size side. In the particle size distribution, the particle size d10 at which the volume-based cumulative frequency from the small particle size side is 10%, the particle size d50 at which the volume-based cumulative frequency from the small particle size side is 50%, and the particle size d90 at which the volume-based cumulative frequency from the small particle size side is 90% are determined.

The obtained d50 is defined as the average particle size. From the obtained d10 and d90, a ratio d90/d10 is calculated.

### (Measurement of Breaking Strength of Active Material Particles)

The positive electrode is extracted from the battery to be measured by the above-described method to obtain a measurement sample. The positive electrode is immersed in an N-methyl-2-pyrrolidone solution and subjected to stirring to peel off the positive electrode active material-containing layer from the current collector. Particles having a diameter of 2 μm or more and 6 μm or less are selected from the peeled positive electrode active material-containing layer. In the positive electrode active material-containing layer, particles having such a diameter can be positive electrode active material particles. The selected particles are used as test particles to be subjected to a test of breaking strength.

As a test instrument, a Shimadzu micro compression tester MCT-510 can be used. An extremely small amount of the test particles is sprayed on a pressure plate of the test instrument to compress the test particles one by one. The breaking strength is calculated by the following formula.

Cs=2.8P/πd²

Cs represents a breaking strength (numerical unit: N/mm² or MPa), P represents a test force (numerical unit: N), and d represents a particle size (numerical unit: mm). Whether the test particles contain the first oxide can be confirmed by performing elemental analysis such as ICP emission spectrometry on the test particles.

According to the first embodiment described above, a battery is provided. The battery includes a positive electrode, a negative electrode, and an electrolyte. The positive electrode contains an oxide containing a transition metal. The transition metal includes nickel, cobalt, and manganese. In the oxide, a number A_{Ni} of atoms of the nickel is 0.7 or more when a total number of atoms of the transition metals is 1. In a hard X-ray photoelectron spectroscopic spectrum for a surface of the positive electrode, a ratio B/A of an area B of a peak having a peak top in a range of 683 eV or more and 686 eV or less to an area A of a peak having a peak top in a range of 851 eV or more and 868 eV or less is 0.07 or more and 0.20 or less. The negative electrode contains a lithium titanium-containing oxide. In a hard X-ray photoelectron spectroscopic spectrum for a surface of the negative electrode, a ratio D/C of an area D of a peak having a peak top in a range of 685 eV or more and 687.5 eV or less to an area C of a peak having a peak top in a range of 455 eV or more and 469 eV or less is 0.75 or more and 1.8 or less. The electrolyte contains a carboxylic acid ester and a cyclic carbonate. A volume of the carboxylic acid ester is at least 2.3 times a volume of the cyclic carbonate. Therefore, a battery having high safety and high input/output performance can be provided.

### Second Embodiment

According to a second embodiment, a battery pack is provided. The battery pack includes the battery according to the first embodiment.

The battery pack according to the second embodiment can include one or more batteries (single batteries) according to the first embodiment described above. The plurality of batteries that can be included in the battery pack can be electrically connected to each other in series or in parallel to form a battery module. The battery pack may include a plurality of battery modules.

Next, an example of the battery pack according to the second embodiment will be described with reference to the drawings.

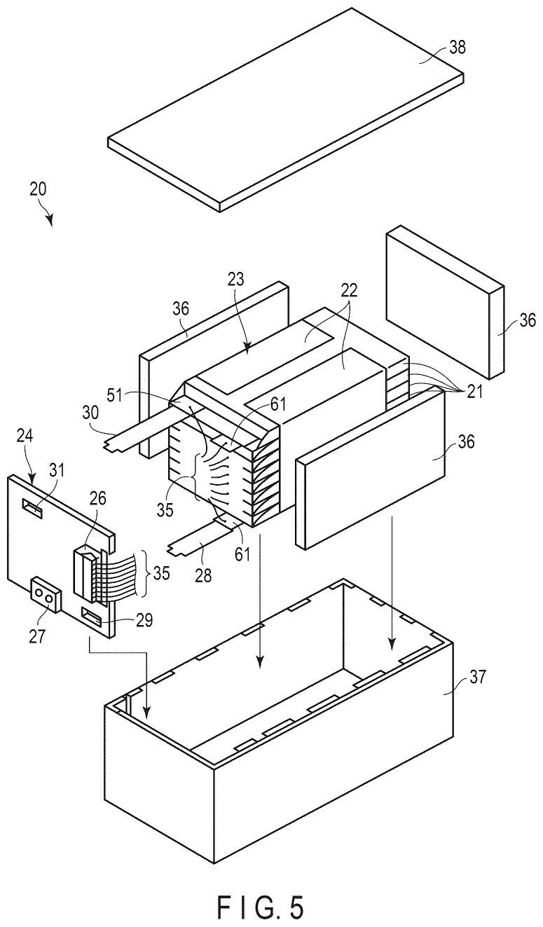

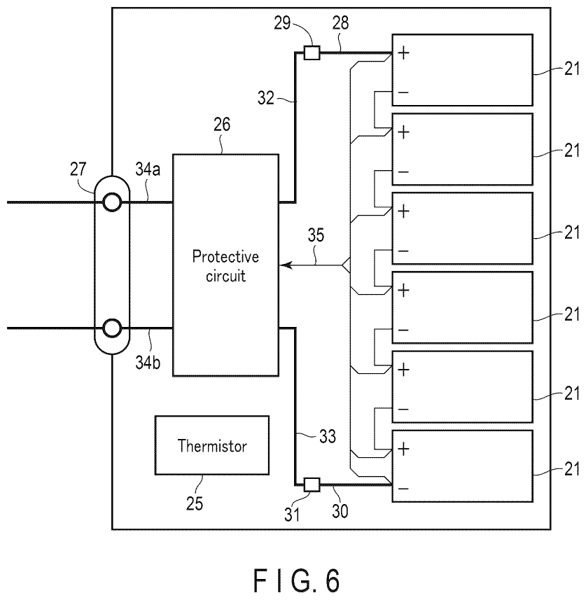

FIG. 5 is an exploded perspective view of an example of the battery pack according to the embodiment. FIG. 6 is a block diagram illustrating an electric circuit of the battery pack of FIG. 5.

A battery pack 20 illustrated in FIGS. 5 and 6 includes a plurality of single batteries 21. The single battery 21 may be an example of a flat battery according to the embodiment described with reference to FIG. 1.

The plurality of single batteries 21 are stacked so that a negative electrode terminal 51 and a positive electrode terminal 61 extending outside are aligned in the same direction, and are fastened with an adhesive tape 22 to constitute a battery module 23. These single batteries 21 are electrically connected to each other in series, as illustrated in FIG. 6.

A printed wiring board 24 is disposed to face a side surface from which the negative electrode terminal 51 and the positive electrode terminal 61 of the single batteries 21 extend. As illustrated in FIG. 6, a thermistor 25, a protective circuit 26, and a power distribution terminal 27 to an external device are mounted on the printed wiring board 24. An insulating plate (not illustrated) is attached to the printed wiring board 24 on a surface facing the battery module 23 in order to avoid unnecessary connection with a wiring of the battery module 23.

A positive electrode-side lead 28 is connected to the positive electrode terminal 61 located in the lowermost layer of the battery module 23, and a tip thereof is inserted into and electrically connected to a positive electrode-side connector 29 of the printed wiring board 24. A negative electrode-side lead 30 is connected to the negative electrode terminal 51 located in the uppermost layer of the battery module 23, and a tip thereof is inserted into and electrically connected to a negative electrode-side connector 31 of the printed wiring board 24. These connectors 29 and 31 are connected to the protective circuit 26 through wirings 32 and 33 formed on the printed wiring board 24.

The thermistor 25 detects the temperature of the single batteries 21 and transmits detection signals to the protective circuit 26. The protective circuit 26 can cut off a plus-side wiring 34a and a minus-side wiring 34b between the protective circuit 26 and the power distribution terminal 27 to an external device under a predetermined condition. An example of the predetermined condition is, for example, when the temperature detected by the thermistor 25 becomes equal to or higher than a predetermined temperature. Another example of the predetermined condition is, for example, when over-charge, over-discharge, over-current, or the like of the single batteries 21 is detected. The detection of the over-charge or the like is performed on each of the single batteries 21 or the entire battery module 23. In a case where each of the single batteries 21 is detected, the battery voltage may be detected, or a positive electrode potential or negative electrode potential may be detected. In the latter case, a lithium electrode to be used as a reference electrode is inserted into each of the single batteries 21. In the case of the battery pack 20 in FIGS. 5 and 6, a wiring 35 for voltage detection is connected to each of the single batteries 21. Detection signals are transmitted to the protective circuit 26 through these wirings 35.

Protective sheets 36 made of rubber or resin are disposed on three side surfaces of the battery module 23 except for the side surface from which the positive electrode terminal 61 and the negative electrode terminal 51 protrude.

The battery module 23 is housed in a housing container 37 together with each of the protective sheets 36 and the printed wiring board 24. That is, the protective sheet 36 is disposed on each of both inner side surfaces in the long side direction and an inner side surface in the short side direction of the housing container 37, and the printed wiring board 24 is disposed on the inner side surface on the opposite side in the short side direction. The battery module 23 is located in a space surrounded by the protective sheets 36 and the printed wiring board 24. A lid 38 is attached to an upper surface of the housing container 37.

For fixing the battery module 23, a heat-shrinkable tape may be used instead of the adhesive tape 22. In this case, the protective sheets are disposed on both side surfaces of the battery module, and the heat shrinkable tape is wound around the battery module and protective sheets. After that, the heat shrinkable tape is shrunk by heating to bundle the single batteries.

FIGS. 5 and 6 illustrate the form in which the single batteries 21 are connected in series, but the single batteries may be connected in parallel in order to increase the battery capacity. Further, the assembled battery packs can be connected in series and/or in parallel.

In addition, a mode of the battery pack is appropriately changed depending on the application. The application of the battery pack is preferably one in which good cycle performance is desired when a large current discharge is performed. Specific applications include power source applications for a digital camera, and in-vehicle applications for a two-wheel to four-wheel hybrid electric vehicle, a two-wheel to four-wheel electric vehicle, and an assist bicycle. The battery pack is particularly suitably used in the in-vehicle applications.

The battery pack according to the second embodiment includes the battery according to the first embodiment. Therefore, a battery pack having high safety and high input/output performance can be provided.

### EXAMPLES

The present invention will be described in more detail with reference to examples described below, but is not limited to the examples listed below, as long as it does not depart from the spirit of the invention.

### Example 1

### <Production of Positive Electrode>

A lithium-containing nickel-cobalt-manganese oxide represented by LiNi_{0.8}Co_{0.1}Mn_{0.1}O₂(NCM811) was provided as a positive electrode active material, acetylene black (AB) was provided as an electro-conductive agent, and polyvinylidene fluoride (PVdF) was provided as a binder.

The provided positive electrode active material was particles of NCM811 which was a single crystal. The ratio d90/d10 of d90 to d10 was 3, the average particle size was 4 μm, and the breaking strength was 174 MPa, as measured for particles of the NCM811. These measurements were performed by the methods described above.

A positive electrode slurry was produced by dispersing the positive electrode active material, the electro-conductive agent, and the binder in N-methyl-2-pyrrolidone (NMP) as a dispersion medium at a mass ratio of 90:5:5. The positive electrode slurry was applied to a positive electrode current collector made of 15-μm aluminum foil, and dried. Thus, a positive electrode having a basis weight of 80 g/m² on one side was obtained.

### <Production of Negative Electrode>

A lithium titanium-containing oxide (TLO) represented by Li₄Ti₅O₁₂ was provided as a negative electrode active material, acetylene black (AB) was provided as an electro-conductive agent, and polyvinylidene fluoride (PVdF) was provided as a binder. A negative electrode slurry was produced by dispersing the negative electrode active material, the electro-conductive agent, and the binder in N-methyl-2-pyrrolidone (NMP) as a dispersion medium at a mass ratio of 90:5:5. The negative electrode slurry was applied to a negative electrode current collector made of 15-μm aluminum foil, and dried. Thus, a negative electrode having a basis weight of 80 g/m² on one side was obtained.

### <Preparation of Electrolyte>

Propylene carbonate (PC) as a cyclic carbonate was provided as a first solvent, and propyl propionate (PP) as a carboxylic acid ester was provided as a second solvent. The first solvent and the second solvent were mixed in proportions of 30 vol % and 70 vol %, respectively. Here, LiPF₆ as an electrolyte salt was dissolved at a concentration of 1 mol/L. Further, lithium phosphorodifluoridate (DFP) and lithium difluoro bis oxalato phosphate (LiDFBOP) were dissolved at concentrations of 0.5 mass % and 1.0 mass %, respectively.

### <Assembly of Battery>

As a separator, a resin separator having a thickness of 15 μm was provided. The positive electrode and the negative electrode were disposed, in a space defined by the separator folded zigzag, such that the positive electrode active material-containing layer and the negative electrode active material-containing layer faced each other with the separator interposed therebetween. Thus, an electrode group was produced.

The produced electrode group was sandwiched between laminate films, and three sides were sealed by heat sealing, whereby the electrode group was housed in a container member made of a bag-shaped laminate film. At this time, one side of the laminate film was not heat-sealed, and provided as an opening in an opened state. This product was put into a dryer, and vacuum drying was performed at 95° C. for 12 hours. After vacuum drying, an electrolyte was injected into the container member in a glove box controlled at a dew point of −50° C. or lower. After the injection, one opened side of the laminate film was sealed by heat sealing in a reduced pressure environment of −90 kPa. This product was used as a battery precursor.

The battery precursor was initially charged to 2.2 V at 1 C (a current value at which a battery reaches a state of charge (SOC) of 0% in one hour when discharged from an SOC of 100%), and then aged in a thermostatic chamber at 60° C. for 48 hours. After the aging, one side of the container member was opened and degassed. After degassing, the one opened side was sealed again in a reduced pressure environment of −90 kPa. Thus, a battery of Example 1 was produced.

### Examples 2 to 4

Batteries were produced in the same manner as in Example 1 except that the proportion of the first solvent and the proportion of the second solvent were set to the values shown in Table 1.

### Comparative Example 1

A battery was produced in the same manner as in Example 1 except that the second solvent was changed to diethyl carbonate (DEC) which was a chain carbonate, and that the proportion of the first solvent and the proportion of the second solvent were set to the values shown in Table 1.

### Comparative Examples 2 and 3

Batteries were produced in the same manner as in Example 1 except that the proportion of the first solvent and the proportion of the second solvent were set to the values shown in Table 1. In Comparative Example 3, the first solvent was not mixed, and the proportion of propyl propionate (PP) as the second solvent was set to 100 vol %.

### Comparative Examples 4 and 7

Batteries were produced in the same manner as in Example 1 except that the proportion of the first solvent, the proportion of the second solvent, and the aging time were set to the values shown in Table 1.

### Comparative Example 5

The proportion of the first solvent, the proportion of the second solvent, the concentration of DFP, and the concentration of LiDFBOP were the values shown in Table 1. A battery was produced in the same manner as in Example 1 except for the above.

### Comparative Example 6

The negative electrode active material was changed to graphite. The proportion of the first solvent and the proportion of the second solvent were set to the values shown in Table 1. A battery was produced in the same manner as in Example 1 except for the above.

### Comparative Example 8

A battery was produced in the same manner as in Example 1 except that the addition of LiDFBOP was omitted.

### (Performance Evaluation)

For the batteries of the Examples and the Comparative Examples, the initial DC resistance and the heat generation amount were tested as follows.

### (DC Resistance Evaluation)

The battery to be measured was constant current, constant voltage (CCCV)-charged to 2.75 V at 25° C. The CCCV charge was terminated when the charging rate converged to 0.02 C. Next, a capacity corresponding to 50% of the 0.2 C capacity was discharged. Thereafter, the battery was discharged at a current of 10 C for 10 seconds while recording the voltage. A value obtained by dividing a voltage difference before and after the 10 C current discharge by a current value was defined as DC resistance (mΩ).

### (Differential Scanning Calorimeter (DSC) Evaluation)

A glass cell was assembled using the positive electrode extracted from the battery to be measured and a lithium metal electrode as a counter electrode. The glass cell was CCCV-charged up to 4.2 V at a charge rate of 0.1 C. Thereafter, the glass cell was disassembled to extract the positive electrode. The positive electrode extracted from the glass cell was washed with ethyl methyl carbonate and then immersed in ethyl methyl carbonate for 1 hour. Then, the positive electrode was dried in a reduced pressure environment of −90 kPa for 3 hours. The active material-containing layer was separated from the current collector of the dried positive electrode to obtain a powdery sample. The sample (5 μg) was weighed, and sealed in a pan together with 60 μL of an electrolyte. As the electrolyte, an electrolyte having the same composition as the electrolyte contained in the battery to be measured was used. The heat generation amount (mJ/mg) was recorded under conditions of a starting temperature of 30° C. and a rate of temperature increase of 5° C./min until the temperature reached 300° C. to obtain a positive electrode DSC heat generation amount.

The manufacturing conditions and performance evaluation results of the batteries of the above Examples and Comparative Examples are shown in Tables 1 and 2. In Comparative Example 1 in which DEC was used as the second solvent instead of the carboxylic acid ester among the manufacturing conditions, the “volume ratio of the carboxylic acid ester to the volume of the cyclic carbonate” was indicated as 0.00. In Comparative Example 3, since the addition of the first solvent was omitted, the symbol “-” is indicated in the column “First solvent” and the column “Volume ratio of carboxylic acid ester to volume of cyclic carbonate”. In Comparative Example 6, since the ratio D/C could not be measured, the symbol “-” is indicated in the column “D/C”.

TABLE 1

| | | | | | | | Volume | | |
|---|---|---|---|---|---|---|---|---|---|
| | | | | | | | ratio of | | |
| | | | | | Proportion | Proportion | carboxylic | | |
| | Positive | Negative | | | (vol %) | (vol %) | acid ester | | |
| | electrode | electrode | | | of | of | to cyclic | | |
| | active | active | First | Second | first | second | carbonate | LiPO₂F₂ | LiDFBOP |
| | material | material | solvent | solvent | solvent | solvent | (mass %) | (mass %) | (mass %) |
| Example 1 | NCM811, | TLO | PC | PP | 30 | 70 | 2.33 | 1 | 1 |
| | single crystal | | | | | | | | |
| Example 2 | NCM811, | TLO | PC | PP | 20 | 80 | 4.00 | 1 | 1 |
| | single crystal | | | | | | | | |
| Example 3 | NCM811, | TLO | PC | PP | 14 | 86 | 6.00 | 1 | 1 |
| | single crystal | | | | | | | | |
| Example 4 | NCM811, | TLO | PC | PP | 10 | 90 | 9.00 | 1 | 1 |
| | single crystal | | | | | | | | |
| Comparative | NCM811, | TLO | PC | DEC | 33 | 67 | 0.00 | 1 | 1 |
| Example 1 | single crystal | | | | | | | | |
| Comparative | NCM811, | TLO | PC | PP | 50 | 50 | 1.00 | 1 | 1 |
| Example 2 | single crystal | | | | | | | | |
| Comparative | NCM811, | TLO | — | PP | 0 | 100 | — | 1 | 1 |
| Example 3 | single crystal | | | | | | | | |
| Comparative | NCM811, | TLO | PC | PP | 25 | 75 | 3.00 | 1 | 1 |
| Example 4 | single crystal | | | | | | | | |
| Comparative | NCM811, | TLO | PC | PP | 25 | 75 | 3.00 | 0 | 6 |
| Example 5 | single crystal | | | | | | | | |
| Comparative | NCM811, | graphite | PC | PP | 25 | 75 | 3.00 | 1 | 1 |
| Example 6 | single crystal | | | | | | | | |
| Comparative | NCM811, | TLO | PC | PP | 25 | 75 | 3.00 | 1 | 0 |
| Example 7 | single crystal | | | | | | | | |
| Comparative | NCM811, | TLO | PC | PP | 30 | 70 | 2.33 | 1 | 0 |
| Example 8 | single crystal | | | | | | | | |

TABLE 2

| | | | | | | Positive |
|---|---|---|---|---|---|---|
| | Aging | Aging | | | | electrode DSC |
| | temperature | time | | | DC resistance | calorific value |
| | (° C.) | (hr) | B/A | D/C | (mΩ) | (mJ/mg) |
| Example 1 | 60 | 48 | 0.11 | 1.10 | 22.1 | 2160 |
| Example 2 | 60 | 48 | 0.13 | 1.20 | 23.1 | 2280 |
| Example 3 | 60 | 48 | 0.12 | 1.39 | 23.9 | 2220 |
| Example 4 | 60 | 48 | 0.14 | 1.62 | 25.8 | 2190 |
| Comparative Example 1 | 60 | 48 | 0.11 | 0.83 | 24.6 | 2551 |
| Comparative Example 2 | 60 | 48 | 0.10 | 0.95 | 21.9 | 2510 |
| Comparative Example 3 | 60 | 48 | 0.16 | 1.46 | 32.0 | 2120 |
| Comparative Example 4 | 60 | 120 | 0.23 | 2.25 | 32.8 | 2150 |
| Comparative Example 5 | 60 | 48 | 0.21 | 2.12 | 33.2 | 2270 |
| Comparative Example 6 | 60 | 48 | 0.11 | — | 35.5 | 2300 |
| Comparative Example 7 | 60 | 10 | 0.06 | 0.71 | 21.9 | 2450 |
| Comparative Example 8 | 60 | 48 | 0.06 | 0.73 | 21.8 | 2300 |

In all of Examples 1 to 4, the DC resistance was low and the heat generation amount was small. That is, it has become clear that safety is high and that input/output performance is high.

In Comparative Example 1 in which a chain carbonate was used as the second solvent instead of the carboxylic acid ester, the value of the ratio D/C was smaller than those in Examples 1 to 4. This is considered to be because the chain carbonate is less likely to be decomposed during aging than the carboxylic acid ester, and thus a decomposition product of the electrolyte is less likely to be formed in Comparative Example 1. As a result of suppressing the formation of the decomposition product of the electrolyte, the amount of the coating formed by adhering to the surface of the negative electrode is reduced. Therefore, it is considered that, in the negative electrode included in Comparative Example 1, the titanium atoms exposed on the surface of the negative electrode were less likely to be covered with the coating, and thus that C became relatively large with respect to D, and that the value of D/C became small. In addition, in Comparative Example 1, both the DC resistance and the positive electrode DSC heat generation amount were higher than those in Examples 1 to 4. It is considered that the chain carbonate contained in Comparative Example 1 had a lower resistance due to a lower ion conductivity than the carboxylic acid ester.

In Comparative Example 2 in which the ratio of the volume of the second solvent/the volume of the first solvent, that is, the ratio of the volume of the carboxylic acid ester to the volume of the cyclic carbonate was as low as 1.00, the positive electrode DSC heat generation amount was higher than those in Examples 1 to 4. This is considered to be because, since the volume of the cyclic carbonate having a lower decomposition start temperature than the carboxylic acid ester was large, the stability of the electrolyte was low, and therefore heat generation associated with gas generation easily proceeded.

Comparative Example 3 containing no cyclic carbonate had a higher DC resistance than Examples 1 to 4. This is considered to be because the ionic conductivity of the electrolyte was lowered due to the fact that the electrolyte contained no cyclic carbonate.

In Comparative Example 4 in which the aging time was prolonged to 120 hours and Comparative Example 5 in which the content of LiDFBOP in the electrolyte was as high as 6 mass %, the value of B/A was larger than 0.20 and the value of D/C was larger than 1.8. In such Comparative Examples 4 and 5, the DC resistances were higher than those in Examples 1 to 4.

In Comparative Example 4, it is considered that since the aging time was too long, the decomposition of the electrolyte excessively proceeded, and a coating containing lithium fluoride was excessively formed on the surfaces of the positive electrode and the negative electrode. In Comparative Example 4, it is considered that since LiPO₂F₂ was not contained, the decomposition of the electrolyte salt was not suppressed. Also as a result, it is considered that a coating containing lithium fluoride was excessively formed.

In Comparative Example 5, it is considered that since the amount of LiDFBOP was large, and a coating containing lithium fluoride was excessively formed on the surfaces of the positive electrode and the negative electrode. It is considered that the resistance increased due to such an excessive coating.

In Comparative Example 6 in which a carbon material was used as the negative electrode active material instead of the lithium titanium-containing oxide, the ratio D/C could not be measured. This is considered to be because no peak was detected in the range of 455 eV or more and 469 eV or less because the negative electrode contained no titanium atom. In Comparative Example 6, the DC resistance was higher than those in Examples 1 to 4. This is considered to be because the negative electrode potential was too low because the carbon material was contained as the negative electrode active material instead of the lithium titanium-containing oxide, and as a result, the carboxylic acid ester was easily reductively decomposed. This is considered to be because an excessive coating was formed in the decomposition reaction.

In Comparative Examples 7 and 8 in which LiDFBOP was not added, the value of B/A was smaller than 0.07 and the value of D/C was smaller than 0.75. In addition, in Comparative Example 7 in which the aging time was shortened to 10 hours, the values of B/A and D/C were smaller. This is considered to be because the content of the substance containing a lithium atom and a fluorine atom in the electrolyte was reduced, and the aging time was shortened, so that the amount of the coating containing lithium fluoride formed on the surfaces of the positive electrode and the negative electrode was reduced. In such Comparative Examples 7 and 8, the positive electrode DSC heat generation amounts were higher than those in Examples 1 to 4.

According to at least one of the embodiments or the examples described above, a battery is provided. The battery includes a positive electrode, a negative electrode, and an electrolyte. The positive electrode contains an oxide containing a transition metal. The transition metal includes nickel, cobalt, and manganese. In the oxide, a number A_{Ni} of atoms of the nickel is 0.7 or more when a total number of atoms of the transition metals is 1. In a hard X-ray photoelectron spectroscopic spectrum for a surface of the positive electrode, a ratio B/A of an area B of a peak having a peak top in a range of 683 eV or more and 686 eV or less to an area A of a peak having a peak top in a range of 851 eV or more and 868 eV or less is 0.07 or more and 0.20 or less. The negative electrode contains a lithium titanium-containing oxide. In a hard X-ray photoelectron spectroscopic spectrum for a surface of the negative electrode, a ratio D/C of an area D of a peak having a peak top in a range of 685 eV or more and 687.5 eV or less to an area C of a peak having a peak top in a range of 455 eV or more and 469 eV or less is 0.75 or more and 1.8 or less. The electrolyte contains a carboxylic acid ester and a cyclic carbonate. A volume of the carboxylic acid ester is at least 2.3 times a volume of the cyclic carbonate. Therefore, a battery having high safety and high input/output performance can be provided.

Hereinafter, the inventions according to the embodiments will be additionally described.
<1> A battery including: a positive electrode, a negative electrode, and an electrolyte, wherein
   the positive electrode contains an oxide containing a transition metal,
   the transition metal includes nickel, cobalt, and manganese,
   a number A_{Ni} of atoms of the nickel in the oxide is 0.7 or more when a total number of atoms of the transition metals is 1,
   in a hard X-ray photoelectron spectroscopic spectrum for a surface of the positive electrode,
   a ratio B/A of an area B of a peak having a peak top in a range of 683 eV or more and 686 eV or less to an area A of a peak having a peak top in a range of 851 eV or more and 868 eV or less is 0.07 or more and 0.20 or less,
   the negative electrode contains a lithium titanium-containing oxide,
   in a hard X-ray photoelectron spectroscopic spectrum for a surface of the negative electrode,
   a ratio D/C of an area D of a peak having a peak top in a range of 685 eV or more and 687.5 eV or less to an area C of a peak having a peak top in a range of 455 eV or more and 469 eV or less is 0.75 or more and 1.8 or less,
   the electrolyte contains a carboxylic acid ester and a cyclic carbonate, and
   a volume of the carboxylic acid ester is at least 2.3 times a volume of the cyclic carbonate.
<2> The battery according to <1>, wherein
   in the oxide, the transition metal is composed of the nickel, the cobalt, and the manganese,
   the oxide is represented by general formula LiₓNi_{1-y-z}Co_{y}Mn_{z}O₂, wherein the x satisfies 0<x≤1, the y satisfies 0<y<0.3, and the z satisfies 0<z<0.3, and
   in the general formula, the 1−y−z, which is a value corresponding to the A_{Ni}, is 0.7 or more.
<3> The battery according to <1> or <2>, wherein
   the positive electrode contains positive electrode active material particles containing the oxide, and
   in a particle size distribution chart of the positive electrode active material particles obtained by a laser diffraction scattering method, a ratio d90/d10 of d90 to d10 is 4 or less.
<4> The battery according to any one of <1> to <3>, wherein
   the positive electrode contains positive electrode active material particles containing the oxide, and
   the positive electrode active material particles have an average particle size of 2 μm or more and 8 μm or less.
<5> The battery according to any one of <1> to <4>, wherein
   the positive electrode contains positive electrode active material particles containing the oxide, and
   the positive electrode active material particles have a breaking strength of 30 MPa or more and 300 MPa or less.
<6> A battery pack including the battery according to any one of <1> to <5>.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A battery comprising: a positive electrode, a negative electrode, and an electrolyte, wherein
the positive electrode comprises an oxide comprising a transition metal,
the transition metal comprises nickel, cobalt, and manganese,
a number A_{Ni} of atoms of the nickel in the oxide is 0.7 or more when a total number of atoms of the transition metals is 1,
in a hard X-ray photoelectron spectroscopic spectrum for a surface of the positive electrode,
a ratio B/A of an area B of a peak having a peak top in a range of 683 eV or more and 686 eV or less to an area A of a peak having a peak top in a range of 851 eV or more and 868 eV or less is 0.07 or more and 0.20 or less,
the negative electrode comprises a lithium titanium-containing oxide,
in a hard X-ray photoelectron spectroscopic spectrum for a surface of the negative electrode,
a ratio D/C of an area D of a peak having a peak top in a range of 685 eV or more and 687.5 eV or less to an area C of a peak having a peak top in a range of 455 eV or more and 469 eV or less is 0.75 or more and 1.8 or less,
the electrolyte comprises a carboxylic acid ester and a cyclic carbonate, and
a volume of the carboxylic acid ester is at least 2.3 times a volume of the cyclic carbonate.

2. The battery according to claim 1, wherein
in the oxide, the transition metal is composed of the nickel, the cobalt, and the manganese,
the oxide is represented by general formula LiₓNi_{1-y-z}Co_{y}Mn_{z}O₂, wherein the x satisfies 0<x≤1, the y satisfies 0<y<0.3, and the z satisfies 0<z<0.3, and
in the general formula, the 1−y−z, which is a value corresponding to the A_{Ni}, is 0.7 or more.

3. The battery according to claim 1, wherein
the positive electrode comprises positive electrode active material particles comprising the oxide, and
in a particle size distribution chart of the positive electrode active material particles obtained by a laser diffraction scattering method, a ratio d90/d10 of d90 to d10 is 4 or less.

4. The battery according to claim 1, wherein
the positive electrode comprises positive electrode active material particles comprising the oxide, and
the positive electrode active material particles have an average particle size of 2 μm or more and 8 μm or less.

5. The battery according to claim 1, wherein
the positive electrode comprises positive electrode active material particles comprising the oxide, and
the positive electrode active material particles have a breaking strength of 30 MPa or more and 300 MPa or less.

6. A battery pack comprising the battery according to claim 1.
